(19) United States
(12) Patent Application Publication
(10) Pub. No.: US 2026/0192716 A1
(43) Pub. Date: Jul. 9, 2026

(54) Fastening Device for a Child Seat

(71) Applicant: Bayerische Motoren Werke Aktiengesellschaft, Muenchen (DE)

(72) Inventor: Robert MAGER, Paehl (DE)

(21) Appl. No.: 19/133,772

(22) PCT Filed: Dec. 13, 2023
(86) PCT No.: PCT/DE2023/100967

§ 371 Date: May 29, 2025

(30) Foreign Application Priority Data
Feb. 2, 2023 (DE) 10 2023 102 638.0

(51) Int. Cl. B60N 2/28

(52) U.S. Cl. CPC B60N 2/2887

(57) ABSTRACT

A fastening device for a child seat is arranged on a vehicle seat of a vehicle that has a seat backrest with a backrest surface. The child seat has an upper child seat holding belt, which is connected or can be connected to the child seat and includes a vehicle-mounted fastening device having a fastening element for fastening the child seat holding belt, and a deflection device arranged between the fastening device and the child seat. A deflection element deflects the child seat holding belt. The fastening device is arranged spaced apart from the deflection device at least in the transverse direction of the vehicle and is characterized in that the deflection element is designed such that it can be folded about a pivot axis.

### BACKGROUND AND SUMMARY

The present invention relates to a fastening device for a child seat on a vehicle seat. It further relates to a vehicle, in particular a motor vehicle, with such a fastening device.

In the effort to prevent the incorrect handling of child seats during their attachment to a vehicle seat and at the same time to ensure a high degree of robustness, there are different fastening methods depending on the place of use of the child seat. One of these methods, which is also a legal requirement in many countries, is the so-called “top tether” method, which is also described in what is called the Isofix standard. It requires the child seat to be fastened by two fastening points arranged under the child seat as well as with a third fastening point at the upper backrest of the child seat. In order to achieve this, an additional upper child seat holding belt (the “top tether”) is used, which is fastened to a fastening element, for example to a support surface of the backrest of the vehicle seat.

In order to improve ease of handling, it is provided that the upper child seat holding belt has a belt tensioning device. In order to be able to arrange this at or in the upper child seat holding belt, the upper child seat holding belt must have a certain length. This is generally achieved by guiding the child seat holding belt over the backrest of the vehicle set and fastening it to the back side of the seat. In vehicles with a curtain rail behind the seats or a separating wall there, this is not possible, so that in this case deflecting devices are used for the upper child seat holding belt.

DE 10 2017 225 553 A1 shows a fastening device for a child seat in a vehicle whose deflecting device is formed by a rod of a headrest of the vehicle seat.

DE 10 2005 013 587 A1 also shows a fastening device for a child seat with a deflecting device formed from a bent metal rod, which is inserted in place of a headrest into the headrest holder of the seat backrest.

The object of the present invention is to provide an improved fastening device whose handling is simplified.

This object is solved by the features of the independent claim(s).

A fastening device for a child seat in accordance with the invention, which is arranged on a vehicle seat of a vehicle that is equipped with a seat backrest with a backrest surface, with an upper child seat holding belt which is or can be connected to the child seat, comprises a fastening device attached to the vehicle with a fastening element for fastening the child seat holding belt and a deflecting device arranged between the fastening device and the child seat, with a deflecting element for deflecting the child seat holding belt, wherein the fastening device is arranged at a distance from the deflecting device at least in the transverse direction of the vehicle. According to the invention, it is provided that the deflecting device is designed such that it can be folded around a pivot axis.

The child seat holding belt can be attached to the child seat and have a fastening means on an end away from this attachment.

The folding design of the deflecting device makes it simple already to provide the deflecting element at the place of assembly of the child seat, then fold it in if the deflecting device is not used, in order to save space and, when it is not in use, to prevent unintentional contact with the projecting deflecting element. The deflecting element is thus designed to swivel between a folded-out position when in use, and a folded-in position when not in use.

Further preferred and advantageous characteristics of the fastening device according to the invention are the objects of the dependent claims.

In a preferred embodiment of the invention, it is provided that the pivot axis of the deflecting element runs in the transverse direction or the longitudinal direction of the vehicle or in a direction with both transverse and longitudinal components. This permits the folding design to be implemented in a simple manner while simultaneously establishing a force flow in the direction of the fastening device, so that the child seat is held securely in position even in the case of a vehicular collision.

It can be preferably provided that the deflecting element is designed to fold out in the direction of the child seat. This permits the forces that primarily occur in a vehicle to be supported in the longitudinal direction, and, advantageously, lower bending torques are exerted on the pivot axis.

The deflecting element can further be designed in a hook shape. This embodiment simplifies the guidance of the upper child seat holding belt and prevents the child seat holding belt from slipping off the deflecting element. Alternatively or additionally, it can be provided that the deflecting element has a flat running surface for the child seat holding belt, wherein the flat running surface can preferably be designed to be parallel with a transverse direction of the vehicle.

The deflecting element can moreover advantageously have a first holder for the deflecting element in a folded-in state. This provides the flattest possible design when the deflecting element is not in use.

Furthermore, it can be advantageously provided that the deflecting device has a first frame and/or a first floor for the placement and/or attachment of the deflecting device. This creates a robust deflecting device. It can in particular be provided that the first frame and the first floor form the first support for the deflecting element. The bearing of the deflecting element that determines pivot axis can further be designed such that it is located on the first frame.

Moreover, the first support for the deflecting element can be provided in a first depression of a crossbar arranged in an upper area of the seat backrest, behind and/or on a side of the seat backrest facing away from the backrest surface of the seat backrest. These measures ensure a preferred, flat arrangement of the deflecting device on or in the crossbar, for example on or in a support surface formed on an upper side of the crossbar. The support of the deflecting element can thereby be retracted into the first depression. Further, at least a part of the first frame can also be arranged in the first depression or form its edge.

In accordance with a preferred refinement of the present invention, the deflecting element has a screw connection, in particular on a first floor of the deflecting element, for the fastening of the deflecting element to the crossbar. This allows the deflecting element to be fastened into the vehicle in a simple manner, so that the child seat holding belt can be securely deflected.

In a further preferred embodiment of the fastening device that can be combined with other embodiments, the fastening device can also be designed such that it can be folded out. This, too, advantageously permits the fastening element and/or the fastening device already to be provided at the place of assembly of the child seat, and to be folded in if the fastening element is not in use in order to save space and to prevent unintended contact with the projecting fastening element.

In accordance with a preferred refinement of the invention, which can also be combined with other embodiments, the fastening device has a second support for the fastening element in a folded-in state. The fastening element is also thereby designed to be folded between a folded-out position when in use and a folded-in position when not in use.

Preferably, the fastening element is arranged in a second depression of the crossbar, and in particular the fastening element can be set into the second depression. Further, the fastening element can also have a second frame and a second floor that can be used for the fastening, attachment, and formation of a second holder for the fastening element. In the state when not in use, this creates a particularly flat embodiment of the fastening element, in which the fastening element is protected in a folded-in state.

The invention is particularly advantageous when a fastening rail and/or fastening groove for the fastening of a curtain or a net is arranged on the crossbar running in a transverse direction on a side of the deflecting element and the fastening device facing away from the child seat, or if a separating panel and/or a separating wall is provided behind the seat backrest. In particular there can be a distance between the deflecting device and the fastening device on the one hand, and the fastening rail and/or fastening groove, so that when the child seat holding belt is fastened to the fastening element the curtain, the net, the separating panel, and/or the separating wall is not damaged or otherwise hindered.

In accordance with a preferred refinement of the invention, it can be provided that the deflecting element has a first frame, wherein the frame has or forms a support surface for the deflecting element in a folded-out state, so that the fastened child seat holding belt holds the deflecting element against the first frame. The deflecting element supports itself thereby against the frame connected to the vehicle structure and transmits the tension forces impinging on the upper child seat holding belt onto the frame and therefore into the vehicle structure. This permits a greater transmission of the force of the belt system onto the vehicle, so that the fastening device can withstand higher forces.

The invention also relates to a vehicle, in particular a motor vehicle, with at least one fastening device as described above.

Preferred example embodiments of the invention with additional characteristic details and further advantages are described and explained in more detail below with reference to the attached drawings.

### BRIEF DESCRIPTION OF THE DRAWINGS

FIG. 1 is a perspective view of an embodiment of a fastening device for a child seat according to the invention;

FIG. 2 is a detailed view of a deflecting element of the first embodiment; and

FIG. 3 shows a second example embodiment of a deflecting element for a fastening device according to the invention.

### DETAILED DESCRIPTION OF THE DRAWINGS

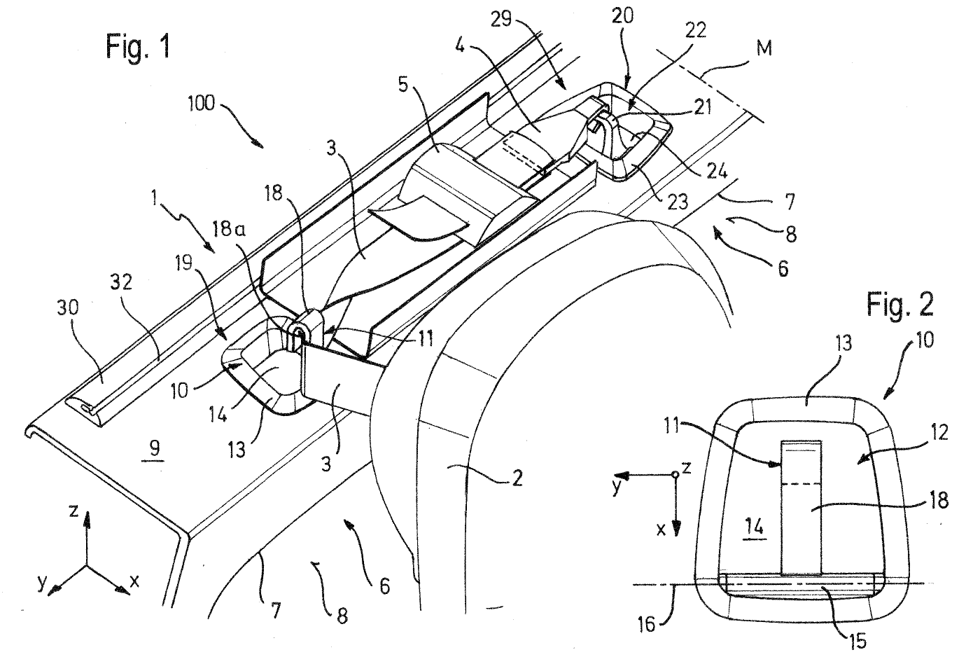

FIG. 1 shows an embodiment of a fastening device 1 for a child seat 2 in a vehicle 100 in a perspective view. The child seat 2 is supported on the seat surface and on the backrest surface 8 of a vehicle seat 6 and is fastened using an upper child seat holding belt 3 to the fastening device 1 connected to the vehicle structure. The upper child seat holding belt 3 is attached with a first end to child seat 2, preferably in the upper area of the back side of the child seat 2. The child seat holding belt 3 has, on its end away from the child seat 2, a belt hook 4 for fastening to the fastening device 1 and a belt tensioning device 5 for tensioning the child seat holding belt 3.

The fastening device 1, in the example shown, is arranged on or in a crossbar 9 of a vehicle structure of the vehicle 100. To support the fastening device 1, the crossbar 9 has a first depression 19 in an area of crossbar 9 facing away from the seat backrest 8 in the longitudinal direction x of the vehicle, and a second depression 29 in an area of the crossbar 9 near a vertical longitudinal middle plane M of the vehicle. The crossbar 9 can form or have a support surface, in particular a hat shelf. Further, on the crossbar 9 there is arranged a fastening rail 30 with a fastening groove 32 for fastening of a curtain, a net, a separating panel, and/or a separating wall. The fastening rail 30 is also called a curtain rail. The fastening rail 30 is located in the longitudinal direction (x) of the vehicle behind the two depressions 19, 29.

The fastening device 1 comprises a deflecting element 10, which is arranged in the first depression 19 of crossbar 9 and is shown in more detail in FIG. 2. The fastening device 1 further comprises a fastening device 20, which is arranged in the second depression 29 of crossbar 9 and is used for the fastening of the belt hook 4. By means of the arrangement of the deflecting device 10 and the fastening device 20 in the two depressions 19, 29, respectively, and therefore in front of the fastening rail 30 in the longitudinal direction x of the vehicle, the child seat holding belt 3 advantageously need not be guided over the fastening rail 30.

The deflecting element 10 comprises a deflecting element 11, which can be retracted into a first holder 12 of the deflecting element 10. The first holder 12 is formed of a first frame 13 surrounding a holder opening and a floor 14 of the holder opening.

The deflecting element 11 in the previous example embodiment of FIG. 1 forms a hook 18 made of a flat bar bent in a U shape, whose first leg facing the child seat 2 is mounted to the first frame 13 on its free, lower end using a pivot body 15 such that it can pivot around a pivot axis 16, and whose second leg forms a hook-like end section bent away from the child seat 2. The first leg of hook 18 has a guide surface 18a on its flat inner side facing away from the child seat, which is used to guide the child seat holding belt 3. The child seat holding belt 3 therefore lies against the first leg and, due to the hook-shaped second leg bent downwards, cannot slip off the first leg. It is therefore securely guided along deflecting element 11. Instead of a flat bar, the hook 18 can also be made from a round bar.

The first frame 13 and thus the first holder 12 of deflecting element 10, which is formed on the side along its circumference by the first frame 13 and on the bottom by the first floor 14, has a trapezoidal shape with rounded corners. The first frame 13 has an interior height that corresponds to the height of the retractable deflecting element 11 in its retracted state, so that the deflecting device 10 is designed to lie flat along the surface of cross bar 9 when the deflecting element 11 is retracted.

The fastening device 20 comprises a fastening element 21 which can be retracted into a second holder 22 of the fastening device 20. The second holder 22 is formed by a second frame 23 surrounding a holder opening and a floor 24 of the fastening device 20.

The fastening element 21 in the present example embodiment is an ISOFIX standard-compliant fastening element 21. The fastening element 21 is designed as a holding arc into which the belt hook 4 can engage. The ends of the fastening element 21 are mounted on a common pivot element (not visible) in the second holder 22 of fastening device 20 in the second frame 23 in such a way that they can pivot.

The second frame 23 and thus the second holder 22 of fastening device 20, which is formed on the side by the second frame 23 and on the bottom by the second floor 24, has a trapezoidal shape with rounded corners. The second frame 23 has an interior height that corresponds to the height of the retractable fastening element 21 in its retracted state, so that the fastening device 20 advantageously lies flat along the surface of crossbar 9 when the fastening element 21 is retracted, and fastening element 21 does not project.

If a child seat 2 is to be fastened onto vehicle seat 6 by means of an upper child seat holding belt 3, that is, by a so-called “top-tether belt” as specified in the ISOFIX standard, the following steps are carried out.
(i) The child seat 2 is placed onto the vehicle seat 6 in a part of the seating surface.
(ii) The deflecting element 11 and the fastening element 21 are folded out of the corresponding first and second holders 12, 22.
(iii) The child seat holding belt 3 is guided around deflecting element 11.
(iv) The child seat holding belt is secured to fastening element 21 with belt hook 4.
(v) Finally, the child seat holding belt 3 can be tensioned using belt tensioning device 5 as needed.

The first embodiment in FIG. 1 and FIG. 2 corresponds, from a point of view along the longitudinal direction x of the vehicle, a right-hand design of the deflecting device 10 and fastening device 20. The fastening device 1 can further have another deflecting device and another fastening device 20 on the other, left-hand side of the vertical lengthwise plane M of the vehicle which are designed and arranged mirror-fashion over the vertical lengthwise plane M of the vehicle.

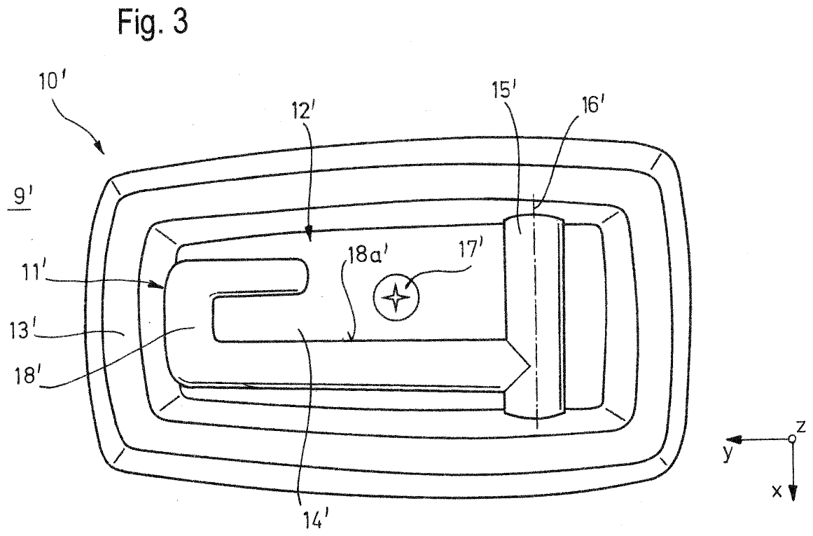

FIG. 3 shows a further embodiment of a deflecting element 10′ with a deflecting element 11′ in a first holder 12′, which is formed by a first frame 13′ and a first floor 14′. The hook 18′ is in this case not facing away from the child seat, that is, not in longitudinal direction x of the vehicle, but rather bent in the transverse direction y of the vehicle. Further, the fastening element 11′ is formed of a round bar and has a round guide surface 18a around which the child seat holding belt 3 can be guided. The fastening element 11′ has on its end away from the hook 18′ a pivot body 15; which can be pivoted around a pivot axis 16′ which in this embodiment runs in the longitudinal direction x of the vehicle. The rotation of pivot body 15′ around the pivot axis 16′ also effects a pivoting of the remainder of the fastening element 11′.

The deflecting device 10′ has in its floor 14′ a screw connection 17′ with which the deflecting device 10′ can be connected on support surface 7 to the vehicle structure.

The invention is not limited to the example embodiments above, which are intended only for the general explication of the core concept of the invention. Within the scope of protection, rather, the device according to the invention can also take on embodiments other than those described above. The device can thereby in particular have characteristics that represent a combination of the specific individual features of the claims.

Reference numbers in the claims, the description, and the drawings are only intended to provide better understanding of the invention and should not limit the scope of protection.

### Reference Number List

1 Fastening device
2 Child seat
3 Child seat holding belt
4 Belt hook
5 Belt tensioning device
6 Vehicle seat
7 Seat backrest
8 Backrest surface
9 Crossbar
10, 10′ Deflecting device
11, 11′ Deflecting element
12, 12′ First holder
13, 13′ First frame
14, 14′ First floor
15, 15′ Pivot bar
16, 16′ Pivot axis
17′ Screw connection
18, 18′ Hook

18a, 18a′ Guide surface
19 First, outer depression of the crossbar
20 Fastening device
21 Fastening element
22 Second holder
23 Second frame
24 Second floor
29 Second, middle depression of the crossbar
30 Fastening rail
31 Fastening groove
M Longitudinal plane of the vehicle
x Longitudinal direction of the vehicle
y Transverse direction of the vehicle
z Vertical direction of the vehicle

1-10. (canceled)

11. A fastening device for a child seat arrangeable on a vehicle seat of a vehicle having a seat backrest with a backrest surface, an upper child seat holding belt for the child seat being connectable to the child seat, the fastening device comprising:
a fastener connected to the vehicle having a fastening element for fastening of the child seat holding belt; and
a deflector arranged between the fastener and the child seat, the deflector comprising a deflecting element for deflection of the child seat holding belt, wherein
the fastener is arranged at a distance from the deflecting element at least in a transverse direction of the vehicle, and
the deflecting element is configured so as to fold about a pivot axis.

12. The fastening device according to claim 11, wherein
the pivot axis of the deflecting element runs in the transverse direction or a longitudinal direction of vehicle, or in a direction with a transverse directional and/or a longitudinal directional component.

13. The fastening device according to claim 11, wherein
the deflecting element is designed so as to fold in the direction of the child seat.

14. The fastening device according to claim 11, wherein
the deflecting element has as hook-shape.

15. The fastening device according to claim 11, wherein
the deflector has a first holder for the deflecting element in a folded-in state.

16. The fastening device according to claim 15, wherein
the first holder for the deflecting element is provided in a first depression of a crossbar arranged in an upper area of the seat backrest, behind and/or on a side of the seat backrest facing away from the backrest surface of the seat backrest.

17. The fastening device according to claim 11, wherein
the fastening element is configured so as to be folded in or out.

18. The fastening device according to claim 16, wherein
the fastener has a second holder for the fastening element in a folded-in state, and
the second holder for the fastening element is provided in a second depression of a crossbar, wherein the fastening element is retractable into the second holder in the second depression of the crossbar.

19. The fastening device according to claim 11, wherein
the deflector has a first frame,
the first frame provides a support surface for the deflecting element in a folded-out state, so that a fastened child seat holding belt tensions the deflecting element against the first frame.

20. A vehicle comprising at least one fastening device according to claim 11.
